(19) United States
(12) Patent Application Publication
(10) Pub. No.: US 2002/0026380 A1
(43) Pub. Date: Feb. 28, 2002

(54) Shopping system of integrated electronic commerce and physical commerce

(76) Inventor: Xiaoqiang Su, Chicago, IL (US)

Correspondence Address: XIAOQIANG SU, APT 1001, 4500 N WINCHESTER AVE, CHICAGO, IL, 60640, US

(21) Appl. No.: 09/927,661

(22) Filed: Aug. 10, 2001

Related U.S. Application Data
(60) Provisional application No. 60/225,150, filed on Aug. 14, 2000.

(51) Int. Cl. G06F 17/60

(52) U.S. Cl. 705/26; 705/27

(57) ABSTRACT

The present invention provides a method and system of effecting commerce in a physically embodied shopping facilities in computerized environment. In a preferred embodiment, a shopping system of the present invention is a physically embodied shopping center comprising a plurality of stores and/or service providers, an electronic-commerce server system, a plurality of local e-shopping client systems, a computer network and a local delivery system. A shopper visiting a shopping center with implemented system of the invention is presented with two basic flexible methods of shopping. In the first method, the shopper may shop by directly visiting the stores in the shopping center and physically looking for goods or services. In the second method, the shopper may choose to shop by using a local e-shopping client system. Local e-shopping client systems are preferably set up in a collective manner inside an e-shopping hall. An e-shopping client system is connected to the electronic-commerce server system via the computer network. The electronic-commerce server system is also preferably connected to the Internet so that the e-shopping front of the shopping center is also accessible by a remote user computer. A shopper using an e-shopping client system may shop for products/services by browsing through the Web pages provided by the electronic-commerce server system, or, by submitting search conditions to the electronic-commerce server system. The shopper can further use a shopping list to expedite a shopping process. When the shopper places an order with a participating store of the shopping center using an e-shopping client system, a delivery may be arranged with the shopping center's local delivery system to have the order delivered to the shopper's desired location, e.g., the local e-shopping client system site where the shopper is doing e-shopping. In regardless of which method a shopper uses to do shopping, the electronic-commerce server system preferably always keep the system updated. The present invention provides an unique and novel system and method in integrating electronic commerce and physics commerce. A system of the invention allows a shopper to have flexible, enjoyable and real-time shopping experience. A system of the invention also allows a shopping center to attract shoppers and effectively sell.

### CROSS-REFERENCE OF RELATED APPLICATIONS

This application is entitled to the benefit of Provisional Patent Application Ser. No. 60/225,150 filed Aug. 14, 2000.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF INVENTION

1. Field of the Invention

The present invention relates to a method and system for effecting physical commerce in a computerized environment. More particularly, although not exclusively, the present invention relates generally to a method and system for integrating electronic commerce (e-commerce) and conventional physical commerce in a physically embodied shopping center.

2. Description of the Related Art

Shopping centers, e.g., shopping malls and cities downtown commercial districts, have become prevalent ways and means for selling. Besides retail sales stores, tenants of units in such shopping centers include such diverse operations as restaurants, banks, movie theaters, coin laundries, copy center, public libraries, light manufacturing facilities, local governmental offices, community agencies, data processing offices, and real estate agencies. References to “merchants”, “stores”, “products”, “orders” and “shoppers”, etc. herein should be taken to include the comparable terms for all shopping center uses.

Trips to a shopping center to purchase goods can be time consuming and frustrating for shoppers, particularly for those shoppers who do not make regular visits, and who are unfamiliar with the general layout of the shopping center or the layouts within a store in the shopping center. And for a shopper who wants to buy goods, much time may be consumed during hunting for goods among various aisles and shelves in a store or among various stores.

Recent years of development of the Internet and electronic commerce seems to address some parts of the problem by eliminating some of a shopper's trips to physically embodied stores. The Internet and World Wide Web (WWW) have allowed retailers to sell on-line through electronic-commerce systems or on-line virtual stores and malls. More and more tradiational brick-and-mortar retailers, e.g., Wal-Mart, have also begun to set up their on-line virtual-store divisions, e.g., WalMart.com. And a shopper can select and purchase products without leaving home or office through on-line shopping. To computer users, on-line shopping may be viewed as a trip to a virtual store that offers many different products and services. For example, Amazon.com and WalMart.com allow users to select and order a wide range of products including books, music and electronics. Another example of on-line retailer is Peapod.com, from whom a shopper can order groceries on-line.

However, to many people, the Internet and World Wide Web still represent a disorganized space. It is a daunting task to navigate the commercial web sites to find satisfactory products. Though in the past several years, graphics and color have been added to text description of products, it is still hard for a shopper to get an accurate overall feeling of the products, especially when the heavy Internet traffic and limited bandwidth discourage sellers to provide detailed high quality graphic descriptions of products. To many people, as access to Internet is by means of Modem, the communication between the user and the web site is generally slow and discouraging. Thus in many cases, a shopper could not make order decision due to lack of sufficient information on products/services. With the users of the Internet keep growing in a fast pace and high speed access still hardly available or affordable for household individuals, the efficiency of service and communications and the capability to provide sufficient information over the Internet is also a concern for electronic shopping. Furthermore, even if a shopper decides to order a product on-line, delivery on time has become a burden on both the seller and the shopper. A shopper has to wait substantial long time typically 1-5 days to receive his/her order, depending on various factors such as product availability, on-line vendor, location of a vendor's distribution center and shipping method. Furthermore, faster delivery generally costs more. And if a shopper decides that he or she is not satisfied with a product when receiving it, it can be a hassle as well as a costly process to return the product back to the retailer, which generally involves at least repackaging and mailing the product back to the seller. The recent bankrupt of an once on-line grocery giant Webvan.com is a typical example of current on-line electronic commerce dilemma.

Recently, some physical retailers such as Gap and Best Buy, begin to install web station or kiosk in some of their individual stores. Such kiosks may help a shopper get more information about a store and products offered, they are mere electronic information booth and do not do much to extend the services of the store. Such kiosks do not eliminate the disadvantages of conventional physical commerce. For example the kiosks do not eliminate needs of shoppers to physically hunt for goods among aisles, shelves or among different stores.

### BRIEF SUMMARY OF THE INVENTION

The present invention recognizes inconveniences and problems that challenge both conventional physically embodied stores and on-line virtual stores. It is among the primary objects of the present invention to provide a system and method for a shopping facility to attract shoppers and effectively sell by allowing shoppers to receive products/services in efficient, flexible ways.

The present invention provides a novel and improved shopping system that facilitates electronic commerce (e-commerce) and computerized system in a physically embodied shopping facility in which a customer can efficiently purchase products or receive services from among a plurality of stores or service units. The system of the present invention presents to a shopper different methods of receiving products/services from a physical shopping facility.

It is an object of the present invention to provide to a shopper a local electronic-shopping (e-shopping) client system, which is connected through high speed network to an electronic-commerce server system of the shopping facility, such that the shopper will be able to obtain sufficient products/services information of the shopping facility in a fast, real-time fashion. Thus the shopper is able to make better purchase decision and merchants are able to effectively sell.

It is an object of the present invention to provide to a system and method for a shopping facility such that a shopper is able to receive said products/services from a plurality of stores in a real-time fashion without physically visiting the suppliers.

A further object of the present invention is to provide control means for each participating store of a shopping facility such that in-store transactions are reflected in a electronic-commerce server system.

Still a further object of the present invention is to provide such a method and system that allows a shopper to place orders with a shopping facility by using a shopping list, wherein the shopping list is used by an electronic-commerce server system to accordingly present to the shopper a list of items offered at the shopping facility. The shopper may then choose to purchase items from such list.

It is a further object of the present invention to provide a method and system for tracking a shopper's historical purchased items from a shopping facility.

In accordance with the present invention, a shopping system of integrated electronic commerce and physical commerce comprises: a collection of actual physically embodied stores, in which a shopper can physically visit and receive from among a plurality of products/services; an electronic-commerce server system that maintains information about products/services offered at the stores; electronic means that a shopper can use to purchase goods without physically hunting for goods or physically visiting a store; and a delivery means.

In a particular implementation, the integrated electronic-commerce and physical commerce system of the present invention is a physically embodied shopping center comprising: a collection of physically embodied stores, an electronic-commerce server system, a plurality of local e-shopping (electronic-shopping) client systems, a computer network and a local delivery system. The shopping center of the present invention might further includes storage units, e.g., lockers, which are dynamically assigned by the shopping center to shoppers for storing personal items and purchased goods.

In accordance with the present invention, a shopper visiting a shopping center of the present invention is presented with two flexible methods of shopping. In the first method, the shopper can do shopping by directly visiting physically embodied stores in the shopping center and physically look for products or services. In the second method, a shopper can choose to do shopping using a local e-shopping client system, which is generally a computer connected to an electronic-commerce server system. Local e-shopping client systems are preferably set up collectively inside a central building, which we call E-shopping Hall here. In an alternative embodiment, they can also be distributed through various locations in the shopping center such as retailer stores, restaurants, banks, and copy center etc. When a shopper places an order by using a local e-shopping client system, a delivery can be arranged with the shopping center's local delivery system to have the order delivered to a location designated by the shopper. As the delivery may occur inside a substantially limited range, e.g., inside the shopping center, the shopper may receive the order in a real-time fashion.

It is a further object to provide a method and system for a shopping facility to allow a shopper to receive multiple services in a parallel manner in a real-time fashion.

The present invention may also further comprises means for releasing the burden of a shopper from carrying around stuff in a shopping facility. In accordance with the present invention, an identified storage space unit may be provided by a shopping center of the present invention to a shopper. Purchased items of the shopper may then be delivered by a local deliver system of the shopping center to the identified storage unit. The customer may then pick up at a later time the purchased items from the identified storage unit.

Therefore, from the foregoing, it is a general object of the present invention to provide a novel and improved method and system for a physically embodied shopping facility to effectively carry out commerce while at the same time allowing customers to shop in efficient, flexible and enjoyable ways. The advantages of the system of the present invention become apparent in detailed description hereinafter.

### BRIEF DESCRIPTION OF THE SEVERAL VIEWS OF THE DRAWING

FIG. 1 is a block diagram of a shopping center in the preferred embodiment that exemplifies the integrated commerce architecture provide by this invention.

FIG. 2 depicts a block diagram of an exemplary Inventory Management Subsystem (IMS) of an electronic-commerce server system.

FIG. 3 depicts a block diagram of an exemplary Customer Management Subsystem (CMS) of an electronic-commerce server system.

FIG. 4 is a flow diagram illustrating an in-store checking out process with a Store Management System (SMS).

FIG. 5 is a flow digram illustrating the process of adding new inventory into a store with a Store Management System (SMS).

FIG. 6 is an illustrative e-shopping front of a shopping center as appeared to a shopper using a local E-shopping Client System (ECS).

FIGS. 7A-7B are flow diagrams of example of a shopper using a shopping system of the present invention.

FIGS. 8A-8C illustrate placing order using shopping list in one embodiment of the present invention.

FIG. 9 depicts a block diagram of an exemplary Order and Deliver Management Subsystem (ODMS) of an electronic-commerce server system.

FIG. 10 depicts a block diagram illustrating an exemplary Delivery Database of the ODMS depicted in FIG. 9.

FIG. 11 is a schematic diagram illustrating one embodiment of delivery arrangement between stores and order delivery locations designated by shoppers.

FIG. 12 illustrates an exemplary delivery-agent index table that maps a delivery to a delivery agent.

FIG. 13 is a flow diagram that illustrates a routine by which a purchased item is delivered.

FIG. 14 illustrates a process of a shopper returning an order to a store.

### DETAILED DESCRIPTION OF THE INVENTION

The present invention provides a method and system that facilitates electronic commerce (e-commerce) in a physically embodied shopping facility, in particular, a shopping center. A shopping system of integrated electronic commerce and physical commerce of generally comprises: at least one actual physically embodied store, in which a customer can physically visit and purchase goods; an electronic-commerce server system; a network; electronic means that a shopper can choose to order products/services without physically hunting for goods or physically visiting a store; means of delivery such that the customer is able to his/her order.

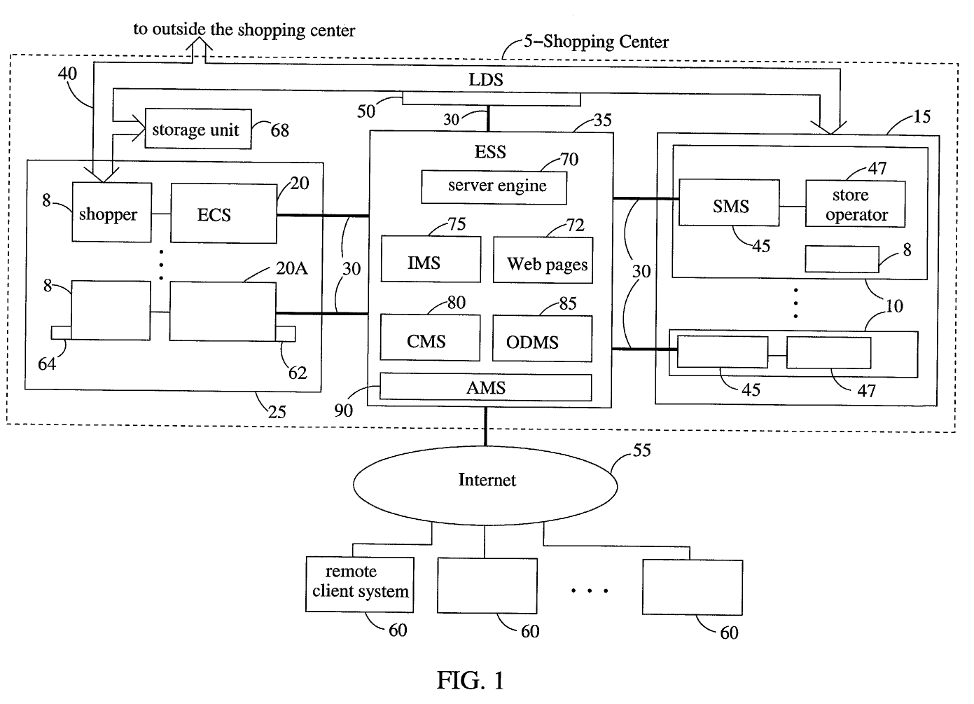

FIG. 1 is a block diagram of a shopping center in the preferred embodiment, generally indicated as 5, that exemplifies the integrated commerce architecture provide by this invention. The system in the preferred embodiment is a shopping center 5 in a computerized environment. The shopping center 5 includes: a collection of physically embodied stores 10, preferably established inside a shopping mall 15; a collection of local E-shopping Client System (ECS) 20, which are preferably user computers preferably set up in divided spaces or cells inside an E-shopping Hall 25; a communication network 30; an Electronic-commerce Server System (ESS) 35; and a Local Delivery System (LDS) 40. A physically embodied store 10 preferably further includes a Store Management Systems (SMS) 45 operated by a Store Operator 47. A physically embodied store 10 through a SMS 45, local E-shopping Client Systems 20, ESS 35 and LDS 40 through a communication interface means 50 (preferably comprising mobile electronic communication means) are connected by a communication network 30 and thus may communicate with each other.

A communication network 30 in a shopping system of the present invention are preferably a high speed computer network for the shopping center 5 in forms of local area network (LAN) and/or wide area network (WAN). The communication network 30 may have various implementation embodiments, e.g., wired or wireless or both. High speed communication and data exchange can be achieved utilizing the communication network such as Fast Ethernet, Gigabit Ethernet or wireless Ethernet. The ESS 35 is also preferably connected to the Internet 55, whereby at least one remote client system 60, e.g., a home user computer, is connected and able to access the ESS 35. Then the remote client system 60 may carry out e-shopping (electronic shopping) in a similar fashion as a local ECS 20 does. E-shopping using a local ECS will be described in detail hereinafter in accordance with the present invention. On the other hand, the ECSs 20 may also be connected to a remote network such as the Internet such that a shopper at a local ECS 20 may be able to communicate with a remote user, e.g, a user at a remote client system 60. A local ECS 20 or a remote client system 60 might also be any electronic device such as a mobile phone that are able to exchange signals with the ESS 35. A communication network 30 may further includes phone lines systems and wireless communication systems that are deployed for communications. For example, a shopper 8 at a local E-shopping Client System 20 site may use a phone installed at said site to communicate with a store customer representative to receive customer service.

A local E-shopping Client System (ECS) 20 is preferably a user computer with display and input means, which is connected to the ESS 35 by the communication network 30. In the preferred embodiment of operation, local ECS 20 are set up in a collective manner inside an E-shopping Hall 25. An E-shopping Hall 25 is generally a building or part of a building, which is divided into rooms or cells with each cell hosting one or more local ECS 20. In an alternative embodiment of operation, local ECS 20 sites might be distributed through out various locations in the shopping center such as retailer stores, restaurants, banks, and copy centers etc.. In another alternative embodiment, a local ECS 20 may be a mobile electronic device that is capable of exchanging signal with the ESS 35. For example, a local ECS 20 may be a hand-held mobile phone or a mobile laptop compute with sufficiently installed software and hardware. A local ECS 20 of the preferred embodiment may further include input means that accepts audio instruction from a user. In an alternative embodiment, the input means of a local ECS 20 might be a touch sensitive screen.

A local ECS 20A of the preferred embodiment may further include an electronic interface means 62 by which an external electronic device 64 can be connected to the local ECS 20A to exchange digital signals. In one embodiment of the electronic interface means 62, it is a wired communication port. In an alternative embodiment, an electronic interface means 62 is a wireless communication interface, such as an infrared or radio frequency (RF) wireless communication interface. In one embodiment of the external electronic device 64, it is a hand-held PDA (Personal Digital Assistant) such as a Palm Pilot™ with sufficiently installed equipment. In an alternative embodiment, an external electronic device 64 is a Smart Card and a corresponding electronic interface means 62 is a Smart Card reader. The shopping center 5 preferably further includes storage units 68 that may be assigned by the shopping center to customers for storing personal item or purchased items. In the preferred embodiment, an Electronic-commerce Server System (ESS) 35 includes a server engine 70, a plurality of Web pages 72, an Inventory Management Subsystem (IMS) 75, a Customer Management Subsystem (CMS) 80, an Order and Delivery Management Subsystem (ODMS) 85. The ESS 35 might further includes an Advertising Management Subsystem (AMS) 90, which comprises means for controlling and scheduling advertisement contents on Web pages that are requested and displayed on various client systems. The various client systems mentioned here include both local ECSs 20 and remote client systems 60.

A server engine 70 of an ESS 35 includes hardwares and softwares for manipulating digital signal and handling communications over a network or within the ESS 35. For example, it generally include a Web Server, which is able to receive at least HTTP requests by various client systems to access Web pages identified by URLs and provide respective Web pages 72 to the various client systems. The Web pages 72 may be either static computer files or files dynamically generated, for example, by a CGI (Common Gateway Interface) program based on information passed from various subsystems of the ESS 35. A server engine may also include application softwares for mathematical calculation and order and payment handling. A server engine 70 may further include FTP server such that computer files may be downloaded from or uploaded to ESS 35.

An Inventory Management Subsystem (IMS) 75 includes databases that hold information on the inventories and resources of the shopping center including stores, products/services and local ECSs of the shopping center 5. A database is generally a computer file or set of computer files, including, if necessary, supporting software components for the retrieval and storage of data. A database may be implemented using any of a number of commercially available database server systems, such as Oracle and Sybase.

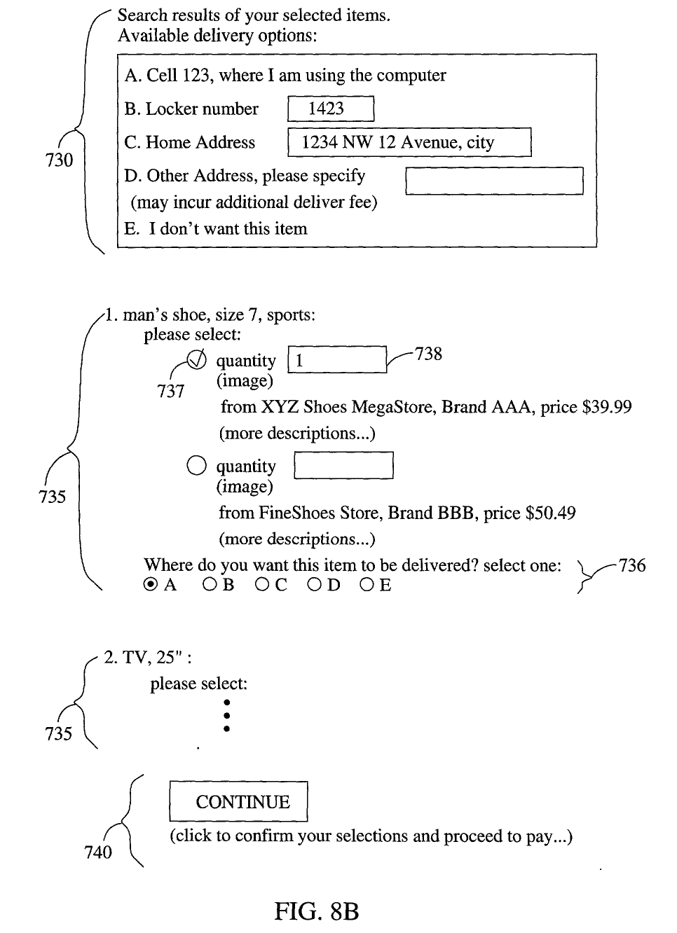

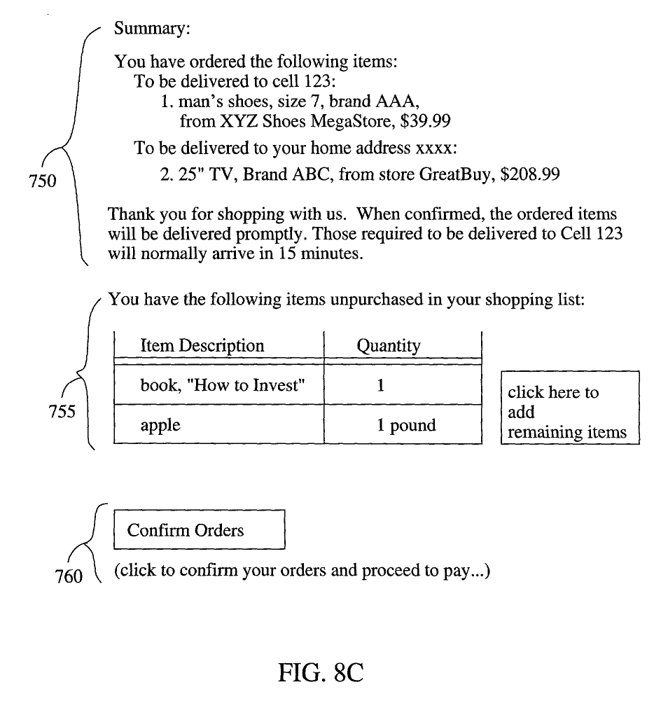

A Customer Management Subsystem (CMS) 80 includes databases that maintain customer related information such as information on customer(s) name, address, payment methods, shopping history and shopping list. In the context above and hereinafter, the term “customer” refers to a shopper who uses the shopping center. The ODMS 85 maintains information on delivered and undelivered purchased items. The LDS 40 arranges delivery according to information provided by the ODMS 85, which will be described in detail hereinafter in conjunction with FIGS. 9-10.

It is appreciated that the boundary of an Electronic-commerce Server System as shown in the drawing by the solid line box indicated by 35 is somewhat arbitrary, in view of the ability to communicate data over networks. The server engine 70, the Web pages 72 and databases of the subsystems of an ESS 35 can reside in one computer or be distributed among several computers or over computer networks. For example, some parts of an ESS 35 such as store-specific Web pages, store-specific database(s) may reside and managed by each store's individually own computer server system, if implemented distributively.

A LDS 40 generally includes a plurality of delivery agents (not shown), whose major task include delivering orders to shopper(s). A delivery agent's task may further include picking up returned orders from a shopper. When a shopper places an order by using a local ECS 20 in the shopping center, a delivery of the order between corresponding store(s) and a shopper's designated location is arranged with the LDS 40. A designated location might be the local ECS site at which the customer is placing the order, or a storage unit 68 assigned to the customer. A designated location might further be a location outside the shopping center. Besides being a request for purchasing goods, an order may also be a request for a service from the shopping center 5 such as laundry service, copying service and library book loan and so forth. For example, a customer may request for a copying service from a copier inside the shopping center. In this case, the LDS might send a delivery agent to pick up the copying material from the customer, and send it to the copier for copying service, and after coping service deliver them back to the customer.

A shopper is preferably recommended to have a membership or establish an account with the ESS 35 of the shopping center 5. With an established membership or account, a shopper 8 may be able to to receive expedited service. A shopper 8 can establish an account by using a local ECS 20, by which the shopper is instructed to interact with the ESS 35. More specifically, the shopper is instructed to input information such as name and address and the ESS 35 checks and stores the input information and issues to the shopper a user identification and password for future accessing services provided by the shopping center. The information may further include the shopper's credit card(s) information. A shopper may also establish an account through a store operator 47. The store operator 47 upon the request of the shopper 8 may input the shopper's information through a SMS 45.

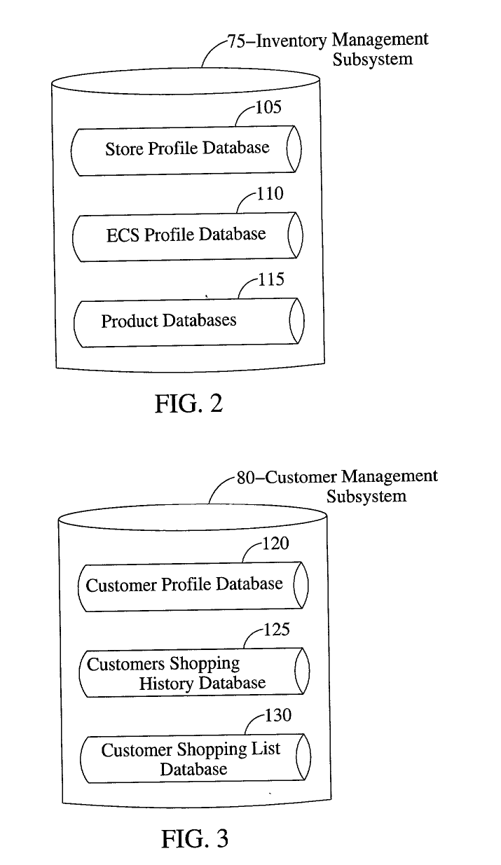

FIG. 2 depicts a block diagram of an exemplary Inventory Management Subsystem (IMS) 75 of the ESS 35. An IMS 75 generally includes a variety of databases including a Store Profile Database 105, an ECS Profile Database 110 and at least one Product Database 115. In the preferred embodiment of the IMS 75, each participating store of the shopping center separately owns a respective Product Database 115 for information on products/services offered by the store. A Product Databases 115 might also reside distributively on respective store's server system, if the ESS 35 is implemented distributively.

A Store Profile Database 105 maintains information on participating stores in the shopping center. Information of a particular store generally includes store-specific information such as the name of the store, store category, its location and a logo image of the store. The below shows an exemplary record of a Store Profile Database:

Store ID: 1001

Store Name: XYZ Shoes MegaStore

Store Category: Retailer; Shoes; Clothes

Location: Shopping Center Western Hall, 3rd floor, 3123

Store Logo: (Image)

An ECS Profile Database 110 is used by the shopping center to maintain and monitor the usage log information of local ECSs 20. The database includes a plurality of records, each associated with a different local ECS 20. Each record generally includes fields for a local ECS 20 the ECS's identification assigned by the ESS 35, the IP address assigned by the the ESS, the ECS's system configuration information, the location of the ECS and the log information file name. An exemplary record of an ECS Profile Database 110 is shown as the below:

ID: 123

Assigned IP: 209.120.12.1

system: PC, 700MHz with infrared Port

Location: E-shopping Hall, 2nd floor, Cell 2013

usage log file name: ECS123.log

By using an ECS Profile Database 110, a shopping center is able to track the usage of each ECS 20. One unique benefit of using an ECS Profile Database becomes apparent when a shopper 8 places an order through an ECS 20 and requests the order to be delivered to the location where he/she is using the ECS for e-shopping. In such a situation, the ESS 35 automatically detects the IP address of the ECS 20 where the order was placed, and by mapping the IP address to the location information in the ECS Profile Database 110, the ESS 35 is able to tell the exact location of the shopper without further requesting the shopper to input the location information.

A Product Database 115 of the IMS 75 maintains information on products and services offered at a respective participating store 10 of the shopping center 5. Information for each product may include product code such as an universal product code (UPC), description, units in stock, stocking location such as aisle and shelf numbers and price of the product. Such information preferably further includes information that links to a digital replica of the product, e.g, a 2D image, virtual 3D reality or an animated presentation of the product. An example of methods to render virtual 3D reality is Virtual Reality Modeling Language (VRML). The below is an exemplary record of a Product Database 115:

Product Code: 00123456

Product Description: ABC Men's T-Shirt, Medium size

Units in Stock: 12

Location within Store: Shelve 3, Aisle 10

Unit Price: $19.99

Image file: 00123456.img

In an alternative embodiment of the present invention, a Product Database 115 may be implemented as a part of a SMS 45 of a store instead of the IMS 75 of the ESS 35. Similarly, store specific Web pages can also be stored in and managed by individual store's SMS 45. The ESS 35 then assimilates the data collected by the communication network 30 from various stores and presents the data in an understandable format to a shopper at a local ECS 20 or a remote client system 60.

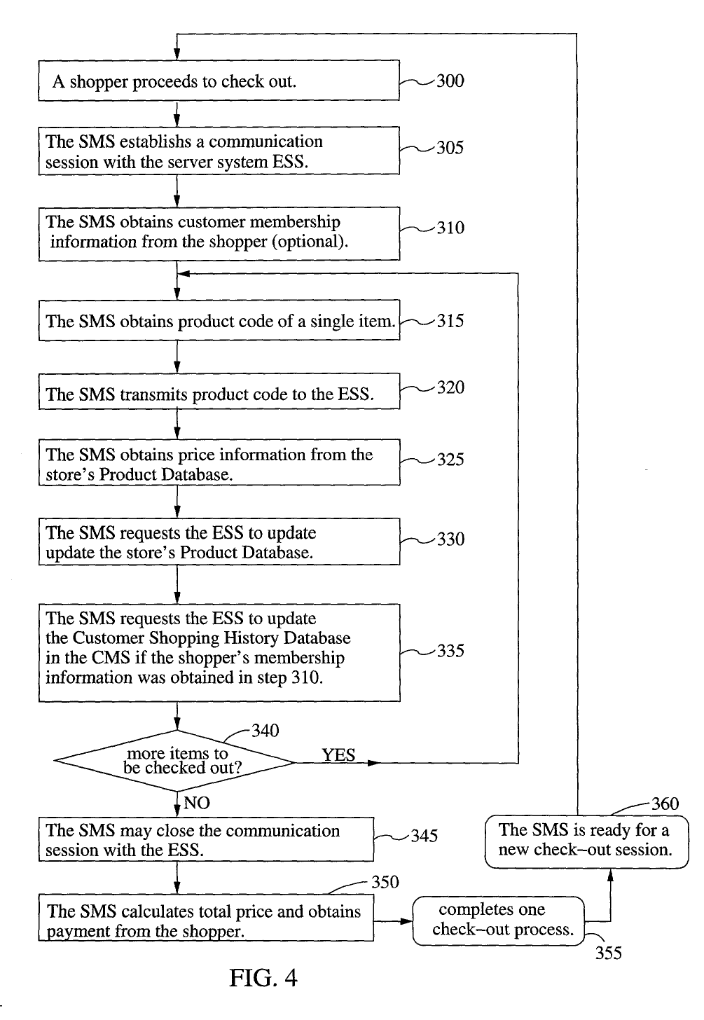

FIG. 3 depicts a block diagram of an exemplary of Customer Management Subsystem (CMS) 80. An exemplary CMS 80 includes a Customer Profile Database 120, a Customer Shopping History Database 125 and a Customer Shopping List Database 130.

A Customer Profile Database 120 generally maintains customer information for customers. For each customer, the customer information includes customer-specific information such as account identification, name of the customer, billing information and address.

The Customer Shopping History Database 125 generally contains detailed historical information of purchased items of each customer. The database includes a plurality of records, each associated with information of each purchased item. Each record may include fields of the customer ID, purchase date and time, purchased item code, item description, purchase price, applied discount information, retailer and special note. The special note field may be used to indicate a canceled or returned order. Each time a shopper 8 purchases an item from a participating store, either through in-store physical shopping or through electronic shopping using a local ECS 20 or a remote client system 60, a new record about the transaction may be added to the Customer Shopping History Database 125. The Customer Shopping History Database's records pertinent to a shopper may be downloaded by the shopper either through a ECS 20 or a remote client system 60. However, it is preferably that a shopper can not modify the shopping history database. It is also preferably that a shopper may only see his/her own shopping history. One skilled in the art would appreciate that the access restrictions may be controlled by the username and password security scheme.

One unique benefit of the Customer Shopping History Database 125 in conjunction with the shopping system of the present invention is that the shopping history records help a customer track his or her shopping records. The customer may then use the records to plan expense, diets and personal properties accordingly. The shopping history records may also be used as an electronic receipt for proof of purchase, thus release customers burden of book-keeping paper receipts.

A Customer Shopping List Database 130 generally maintains electronic shopping lists for customers who have registered an account with the ESS 35. A shopper with an account or membership with the shopping center may store at least one shopping list in the Customer Shopping List Database 130. A shopping list for a customer includes a plurality of records, each associated with an entry for a future potential purchase item of the customer. Each record in the shopping list includes such information as the customer ID, description of the item, quantity wanted and the date when the entry is added to the shopping list and a flag field to indicate if the item has been purchased. An exemplary record of the Customer Shopping List Database 130 is shown in the below:

Customer ID: 0123123

Entry Number: 01

Entry Date: 04/09/00

Entry Description: Man's shoe, size 7, sports

Quantity: 1 pair

Has purchased (flag): No

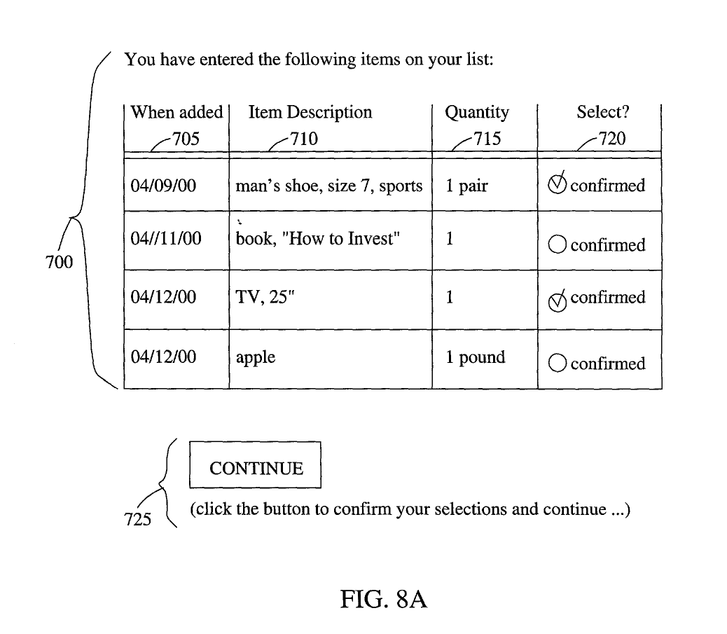

A shopper 8 may use either a local ECS 20 or a remote client system 60 as depicted in FIG. 1 to record or update the shopping list through their input means. The shopper later can request the ESS 35 to use the shopping list to do automatic search for said list items. When an item on the list is purchased, the ESS may delete the item's record from the Shopping List Database 130 or indicate so in the flag field. Use of a shopping list to do an e-shopping is described in detail hereinafter in conjunction with FIG. 8A-8C.

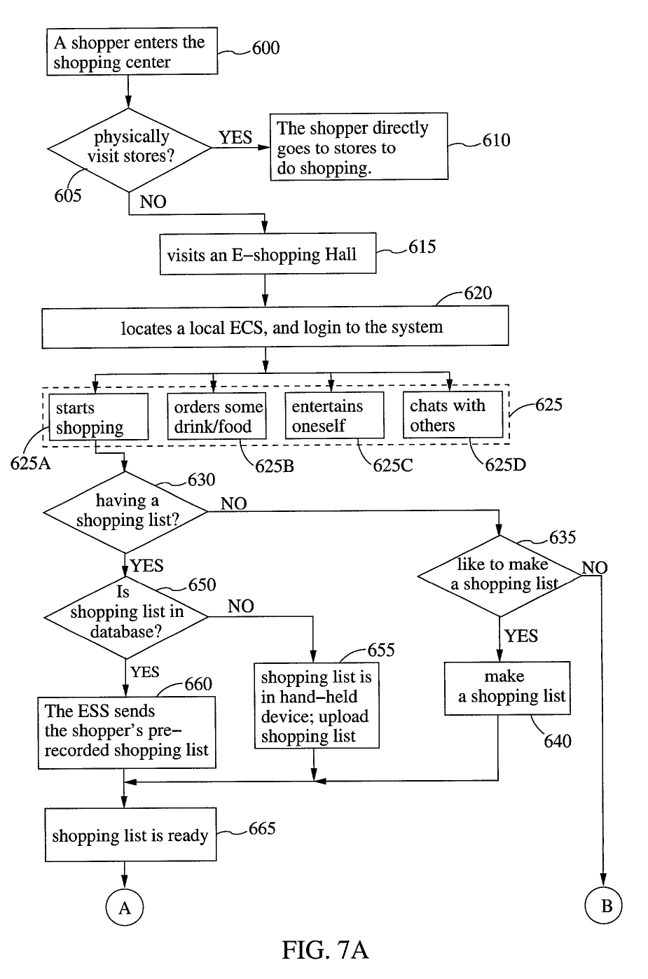

Now with reference to FIG. 1, a shopper 8 entering a shopping center of the present invention has two basic choices of shopping methods. In the first method, the shopper may go directly to a physically embodied store 10, where he/she can physically select goods and receive services in the store. In the second method, the shopper may use a local ECS 20 to do e-shopping. The second method of shopping using a local ECS 20 is described in detail hereinafter in conjunction with FIG. 6. A shopper may also do conventional physical shopping using the first method to shop for some products and do e-shopping using the second method to shop for other products. In a preferred embodiment of operation, the ESS 35 of the shopping center updates the store's Product Database 115 of IMS 115 (in FIG. 2) and Customer Shopping History Database 125 of CMS 80 (in FIG. 3) in real-time, in regardless of which shopping method the customer uses.

In the first method, a shopper 8 visiting the shopping center 5 goes directly to a store 10, where he can physically touch and select goods and/or receive services in a conventional way. After finishing selection, the customer proceeds to a check-out counter (not shown) in the store to pay and check out selected goods. Processing of the order can be carried out in a similar way as in a conventional physical commerce system. For example, the shopper carries his or her shopping cart of goods to a sales person or a store operator 47 at a check-out counter, and the sales person examines the selected goods and gets price information, then the sales person gets total price information and requests the shopper for a payment with a payment method of the customer's choice. The shopper pays the indicated price and gets a receipt. The transaction is then closed.

In accordance with the present invention, an in-store transaction processing is preferably executed through a Store Management System (SMS) 45, such that an in-store transaction may be executed and communicated with the ESS 35. Therefore, it is preferred that each participating store 10 in the shopping center installs a SMS 45. A SMS 45 is generally a computer system associated with it a display, some input devices, storage media such as hard drive and software objects for executing transactions and communication with the ESS 35. Input devices generally includes a keyboard and mouse which are used by a store operator 47 to input information to the SMS 45. Input devices may further includes other electronic devices such as bar code scanner or magnetic reader that are used to scan in product information or to read user cards such as membership card or credit card.

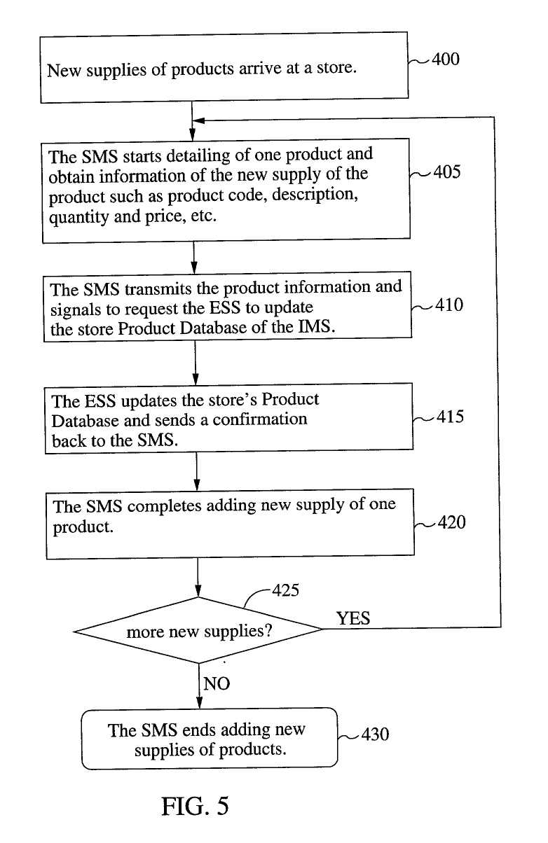

FIG. 4 is a schematic flow diagram of in-store checking out process with a SMS 45, in accordance with a preferred embodiment of the present invention. In step 300, a shopper 8 proceeds to a check-counter in a store 10 where the shopper has done physical shopping. The shopper is ready to check out selected items from the store, and the SMS 45 starts a new check-out session. In step 305, under the operation of a store operator 47, the SMS 45 establishes a communication session with the ESS 35. The communication is first initiated by a request of establishing communication session from the SMS 45 to the ESS 35, the ESS 35 then acknowledges the request and the communication session is established.

With referring to FIG. 4, in step 310, if the shopper has previously established a membership account with the ESS 35, he/she may have the choice to provide such membership information such that the purchases of the shopper can be recorded in associate with the shopper's account in the Customer Shopping History Database 125 of the CMS 80 depicted in FIG. 3. Under the operation of the store operator 47, the SMS 45 obtains customer membership or account information from the shopper. It is noted that several methods may be used to obtain membership information. In one embodiment of operation, each user account is associated with a membership card, and a membership card is readable by a electronic device such as a bar code scanner connected to the SMS 45. In an alternative embodiment of operation, the store operator may just manually input the membership number or account ID of the customer into the SMS 45.

With referring to FIG. 4, In step 315, the SMS 45 obtain the product code of one single item. Generally the product code is a bar code identifying said item and is readable by an electronic device such as a bar code scanner. In step 320, the SMS 45 transmits the product code to the ESS 35 and requests for price information. In step 325, the SMS 45 obtains price information from the ESS 35, in particular, from the store's Product Database 115 (depicted in FIG. 2). In step 330, the SMS 45 sends signal to the ESS 35 to request the ESS to update the store Product Database 115, in particular, to decrease the product units in stock as recorded in the Product Database by the quantity being checked out. In step 335, if the SMS 45 has obtained the shopper's membership information from the previous step 310, the SMS 45 then sends signal to request the ESS 35 to update the Customer Shopping History Database 125 in the CMS 80, in particular, to add a new historical record on the newly purchased item to the Customer Shopping History Database. Otherwise, the SMS 45 simply continues checking out. In step 340, if the shopper has more items to check out, the SMS 45 loops to step 315, else the SMS 45 continues at step 345. In step 345, the SMS 45 may close the communication session with the ESS 35. In step 350, the SMS 45 calculates the total amount due and obtains payment from the customer. In step 355, the SMS 45 completes the check-out for the shopper and finishes the transaction. Thus the shopper receives the purchased products or the products are said being delivered to the shopper. In step 360, the SMS 45 is ready for a new check-out session and loops to step 300.

In the exemplary schematic diagram in FIG. 4, in particular, in step 330, the SMS 45 sends a signal to request the ESS 35 to update the Product Database 115, and in step 335, the Customer Shopping History Database 125 whenever a new item is being checked out. In an alternative embodiment of operation of the SMS 45, the SMS 45 may temporarily store all or partial check-out information including purchased items information and customer membership information in local storage media, and at the end of the check-out session or in the middle of the session when information of a plurality of purchased items has been collected, the SMS 45 sends all together the temporarily stored information and signals to request the ESS 35 to update the Store Products Database 115 and the Customer Shopping History Database 125. Thus reduce the number of back-and-forward communication cycles between the SMS 45 and the ESS 35.

Besides synchronizing in-store check-out process with the Product Database 115 in the ESS 35, a SMS 45 may further comprise means for recording new supplies and inventory, such that the process of adding new supplies to a store may also be synchronized with the store's Product Database 115.

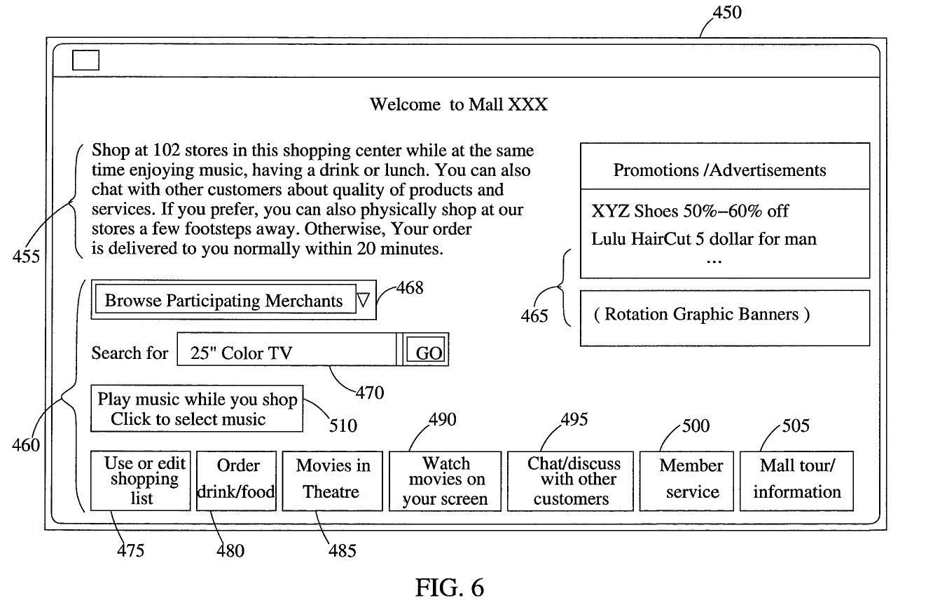

FIG. 5 is a flow diagram illustrating the process of adding new inventory to a store 10 using a SMS 45. In step 400, new supplies of products arrive at the store. In step 405, the SMS starts detailing of one product. The SMS 45 first obtains information of the new supply of the product. The information may include the product's Universal Product Code (UPC), description, units added, location inside the store and price. The product information may be in the form of digital signals provided by the supplier. For example, in one embodiment of operation of obtaining the product information, the information can be stored in a computer floppy disk supplied by the supplier in a format readable by the SMS 45. In an alternative embodiment of operation, the product information may be manually input into the SMS 45 by an authorized store operator 47. For example, the operator can use a bar code scanner to scan in the product code and then manually input the quantity and price information of the product using a keyboard attached to the SMS 45. The SMS 45 maintain the information in a format such that the information is convertible to a record of the store Product Database 115 (depicted in FIG. 2). In step 410, the SMS 45 transmits the product information and signals to request the ESS 35 to update the store Product Database 115. In step 415, the ESS 35 updates the store Product Database 115 with the information submitted by the SMS 45. The update may involve creating a new record for the new product added to the store or simply modifying certain fields, e.g. increasing the number of units in stock of a existing product. The ESS 35 may then send a confirmation back to the SMS 45. However, the ESS 35 sending back an update confirmation to the SMS 45 may not be necessary. In step 420, the SMS 45 completes adding new supply of one product. In step 425, if there are more new supplies of other products, the SMS 45 will loop to step 405, else the SMS continues at step 430. In step 430, the SMS 45 ends adding new supplies of products to the store. It is noted that a store operator may use a SMS 45 to updating inventory information in the similar way as adding new inventory to the store.

SMS 45 may further comprises means that allow a store operator 47 to retrieve customers' and sale information from the ESS 35. Such information might include a customer's name, address and shopping history. The ESS 35 preferably implements certain business rules to restrict what kind of information is accessible to a specific store. For example, a store operator 47 may be allowed to access only those portion of a customer's shopping history that is related to orders from the store. The SMS 45 may further include means of extensibility such as standardized interface to communicate with other softwares or to add software modules to perform additional functions, for example, doing sales data analysis.

With reference to FIG. 1, though a shopper may use the first method of shopping, i.e., physically visiting stores and selecting goods for purchase as described in the above, for some shoppers, physically hunting goods from one store to another could be tedious and frustrating. With a shopping system of the present invention, a shopper 8 is also presented with a choice to do e-shopping using a local ECS 20 without physically hunting for goods from store to store in the shopping center.

Using a local ECS 20, a shopper can retrieve goods and services information about a shopping center 5 through communication with an ESS 35 over local high speed communication network 30. When the shopper places an order using a local ECS, a request and instruction of delivery is sent by the ESS 35 to a LDS 40, which arranges a delivery of the ordered goods to a shopper-designated location. A typical shopper-designated location is the site of ECS 20 at which the shopper is doing e-shopping. The LDS 40 may also deliver goods to another desired place, for example, a storage unit 68 assigned to the shopper. The purchased products may further be arranged to be delivered to a location outside the shopping center 5, for example, to the home address of the shopper. For delivery occurs within the shopping center 5, which is preferably of limited range, delivery can be made in a substantially short time. The shopper may further be given the choice to decide upon seeing the goods if he or she want to keep the products. If the shopper is not satisfied with any product he or she ordered, the product can be immediately or at a later moment delivered back to the store by a deliver agent (not shown) of the LDS 40. This real-time shopping without visiting a particular store is of substantial benefits compared to today's WWW on-line shopping, by which it typically takes days for a shopper to receive order products. On the other hand, for shoppers who like visiting stores, the physically embodied individual stores in the shopping center have their own characteristics as a conventional physical store. Using whichever methods of shopping, a shopper is able to receive real-time service. The electronic commerce and physical commerce are thus integrated. The whole shopping center appears as one integrated virtual and real physically embodied super mall to a shopper visiting the shopping center.

FIG. 6 is an illustrative e-shopping (electronic-shopping) front 450 of a shopping center of the present invention as appeared to a shopper using a local ECS 20 for e-shopping. In a preferred embodiment, an e-shopping front is a Web page. The sample Web page in FIG. 6 was sent from the ESS 35 to a local ECS 20. The e-shopping front 450 is implemented such that a shopper 8 using a local ECS 20 is able to receive multiple services or perform multiple parallel tasks in a real-time manner. In accordance with the present invention, the exemplary electronic shopping front Web page 450 includes a text description field 455, functional section 460 and an advertisement field 465. The contents of the advertisement field 465 are controlled by the Advertisement Management Subsystem (AMS) 90 of the ESS 35. The functional section 460 includes various functional subsections, e.g., buttons, clickable text and images, links, etc., which a shopper may select to perform different tasks or activities. The exemplary functional section here includes a pull-down menu 468 that a shopper can use to browse and select participating stores or service providers and respective available products and services. A shopper may also input search condition in text field 470 to search for a specific store or products. The exemplary functional section further includes subsections such as subsection 475 that instructs a shopper to use or edit a shopping list to shop, subsection 480 that instructs a shopper to order some drink or food, subsection 485 that instructs a shopper to purchase a ticket for a movie on show in the shopping center, subsection 490 that instructs a shopper to watch a movie on the screen, subsection 495 that instructs a shopper to chat or discuss on line with other shoppers, subsection 500 that instructs the shopper to receive on-line customer service, subsection 505 that instructs a shopper to take a virtual tour and find out more information about the shopping center and subsection 510 that instructs a shopper to play music in the background while doing e-shopping. One skilled in the art would appreciate that these various sections and subsections can be omitted or rearranged or adapted in various ways. One skilled in the art would also appreciate that additional sections and subsections may be added depending on available service in the shopping center. The unique integrated implementation of the system of the present invention conveniently allows a user to carry out shopping-related activities while at the same time entertaining oneself or seeking advice and opinions from other customers. The computerized shopping system in a localized environment makes high speed communication and data transfer very feasible and thus allows complicated data including textual, graphic, audio, video signals and 3D virtual reality to be presented to a shopper. The shopper is thus able to receive sufficient information to make better buying decisions.

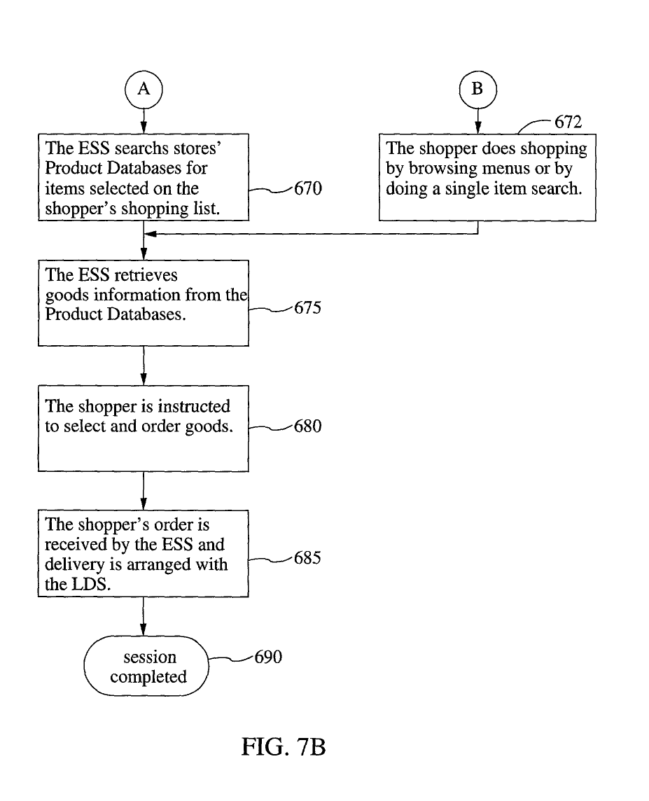

With now referring to FIG. 7A-7B, a flow diagram of an example of a shopper using a shopping system of the invention is illustrated. In step 600 in flow diagram of FIG. 7A, a shopper 8 enters the shopping center. In step 605, the shopper determines which method he or she would like to use to do shopping in the shopping center, e-shopping or physical shopping. If the shopper likes to physically visit stores to buy goods, then the shopper continues at step 610, else the shopper continues at step 615. In step 610, the shopper directly goes to stores in the shopping center to do shopping.

Referring to FIG. 7A, in step 615, the shopper visits an E-shopping Hall 25 and continues at step 620. In step 620, the shopper finds an available local ECS 20 and login to the ECS. In step 625, the shopper may choose to receive multiple services in a parallel manner as exemplified in parallel steps 625A-625D. In step 625A, the shopper begins e-shopping. In step 625B, the shopper orders a drink from the shopping center by selecting the functional subsection 480 on the electronic front 450 of FIG. 6. Typically within minutes, the ordered drink is delivered to the shopper. In step 625C, the shopper plays a music by selecting functional subsection 510 on the electronic front 450 of FIG. 6. In step 625D, the shopper selects functional subsection 495 on electronic front 450 to chat with other shoppers for comments on products and services in the shopping center. While the shopper enjoys drinking in step 625B, entertaining himself in step 625C and getting advice from other customers in step 625D, the shopper continues shopping at step 630.

Referring to FIG. 7A, in step 630, if the shopper has a shopping list, then the shopper continues at step 650, else the shopper continues at steps 635. In steps 635, if the the shopper wants to make a shopping list, the shopper continues at step 640, else the shopper continues at step 672 in FIG. 7B. In step 640, the shopper makes a shopping list and continues at step 665. In a simple embodiment of operation, making a shopping list comprises the step of constructing a list of string that representing items that a shopper desires to buy. In step 650 in the flow diagram of FIG. 7A, if the shopping list has been previously recorded and stored in the Customer Shopping List Databases 130 of the CMS 80 (depicted in FIG. 3), then the shopper continues at step 660, else the shopper continues at step 655. In one embodiment of operation of shopping list, the shopping list could have been built and recorded in the ESS 35 in a former time using a remote client system 60 by the shopper. In another embodiment of operation of shopping list, the shopping list could also have been built by the ESS 35 according to the shopping history of the customer. In step 655, the shopper uses a shopping list that he or she has previously recorded in a external electronic device 64 (in FIG. 1) such as a hand-held PDA (Personal Digital Assistant). Through an electronic interface means 62 connected with the local ECS 20, the shopper may upload the shopping list from his or her hand-held PDA to the local ECS 20. Otherwise, in step 660, the local ECS 20 sends a request to the ESS 35 to retrieve shopping lists that has been previously recorded in the Customer Shopping List Databases 130. The ESS 35 responds to the request by converting the request to SQL and calling upon the database management system to retrieve the customer shopping list from the Customer Shopping List Databases 130. The ESS 35 then formats and sends back the requested information to the local ECS 20. Exemplary process of using electronic shopping list to do shopping is described in detail in conjunction with FIGS. 8A-8C. In step 665, after the operation from steps 650 to 660, the shopping list is retrieved and displayed to the shopper. The shopper is also allowed to modify the shopping list before submitting the shopping list to the ESS 35 to perform automatic search for a lists of products. The shopping list is then ready. The local ECS 20 then sends the final shopping list to the ESS 35.

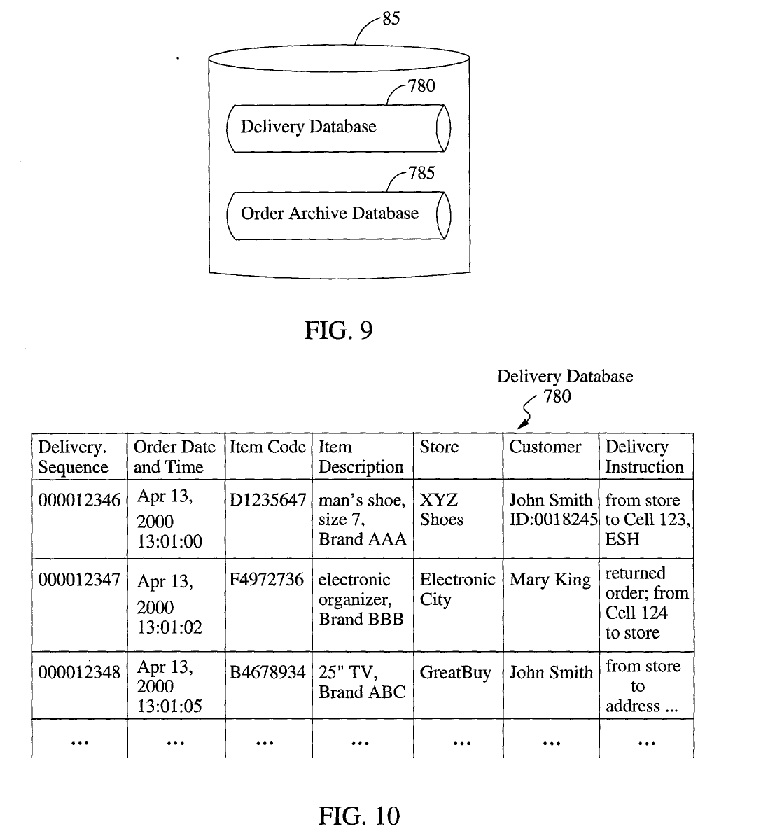

Referring to FIG. 7B, in step 670 in FIG. 7B, the ESS 35 searches for all stores product databases for goods indicated on the shopping list and continues at step 675. In step 672, the shopper does e-shopping by browsing menu 468 or by searching for a single item in search field 470 on the electronic front 450 of FIG. 6 and continues at step 675. In step 675, the ESS 35 retrieves products information from the product databases and formats the information as Web page(s) and send the formatted information to the local ECS 20. The information includes product-specific information such as products description, price and suppliers. In step 680, the shopper is instructed to select goods and make purchase. In step 685, orders from the shopper is received by the ESS 35 and the order is processed and a delivery arrangement is made with the LDS 40. The order processing may include the ESS 35 calculating total price and sending new Web pages requesting payment methods from the shopper, the ESS verifying payment methods and settling the payment. One skilled in the art would appreciate that existing commercial payment systems and softwares may be used here in payment handling. The description of delivery arrangement is described in detail hereinafter in conjunction with FIGS. 11-14. In step 690, one transaction is completed. The shopper may continue shopping.

FIGS. 8A-8C illustrate placing order for a list of items in one embodiment of the present invention. However, it is appreciated that the process described here may be applied to a more general ordering process. Furthermore, in a broad sense, shopping for a single item may be understood as shopping using a list with one single item.

FIG. 8A illustrates a display of a Web page on a local ECS 20 describing a shopping list 700 used by a shopper. The shopping list 700 could have been (1) retrieved from the Customer Shopping Lists Database 130 as described in step 660 in FIG. 7A; or (2) uploaded from the shopper's hand-held device 64 through the electronic interface means 62 of a local ECS 20 as described in step 665 in FIG. 7A; or (3) just made by the customer in step 640 as described in the flow digram FIG. 7A. Field 705 of the shopping list indicates when an entry was added to the shopping list. Item Description field 710 indicates descriptions of each item that shopper intends to purchase. Quantity field 715 indicates the quantity the shopper wants for a particular item. Select field 720 includes an indicator to be used by the shopper to confirm the selection. If the shopper changes his or her mind and does not want an item any more, the shopper can use the indicator in the Select field 720 to unselect the item. The Web page may further includes a means such as a button to allow the shopper to add additional item at this point. When the shopper selects the “CONTINUE” button 725 in FIG. 8A, the local ECS 20 sends a message to the ESS 35 requesting that the selected items on the shopping list 700 be searched in Products Databases 115 of the participating stores of the shopping center. The ESS 35 then searches the Products Databases, and provides to the ECS 20 new page(s) that shows the search results, which is exemplified in FIG. 8B.

FIG. 8B illustrates the display of an exemplary Web page indicating the search results based on the shopping list in FIG. 8A. Delivery options group 730 shows a list of options which the shopper can select after each item's search result in 735 to indicate where he or she wants such item to be delivered. In this example, choice “A” indicates a delivery to the local ECS site where the shopper is placing order, choice “B” indicates locker NO. 1423, which was previously assigned by the shopping center to the shopper, choice “C” indicates the home address of the shopper, choice “D” indicates some other address that the shopper may provide, and choice “E” may be used by the shopper to discard the item from the purchase list. The options in the options group 730 are added as exclusive choice in delivery options section 736 after each item's search result 735. In this example, the search for “man's shoes, size 7, sports” in the shopping list 700 yields a list of products that match the description of the item in the shopping list. The information presented to the shopper generally includes product-related information such as image, retailer/supplier, price, detailed description and so on. The search result also includes selection field 737 and text field 738 to allow the shopper to indicate the exact product and quantity the shopper wants. The delivery options section 736 allows a shopper to indicate where a specific item should be delivered. One skilled in the art would appreciate that there are various methods to present the search results 735 and elements within. For example, delivery options section 736 can also be implemented as a pull-down menu. After the shopper finishes making selections or input, the shopper can proceed to confirm the selections by selecting the “CONTINUE” button 740.

FIG. 8C illustrates an exemplary Web page summarizing order selection of the shopper. Summary 750 summarizes the products the shopper selected, their price and where they will be delivered. Different items can be delivered to different places depending on the choice of the shopper in delivery options section 736 for each ordered item. The Web page may further includes a section 755 to indicate remaining unpurchased items in the the shopper's original shopping list 700 illustrated in FIG. 8A. Section 755 may further include options to allow a shopper to shop for unpurchased items on the shopper's shopping list. The shopper then confirms the orders and proceeds to pay by selecting button 760. The order information is then send to the ESS 35 for processing. The order processing may include the ESS 35 calculating the total amount due and sending new Web pages requesting payment methods from shopper, the ESS verifying payment methods and settling the payment. One skilled in the art would appreciate that existing commercial payment systems and softwares may be used here in payment handling without modification.

FIG. 9 is a box diagram of an exemplary Order and Delivery Management System (ODMS) 85. An ODMS 85 generally includes a Delivery Database 780 and an Order Archive Database 785. The Delivery Database 780 contains information about purchased items that have not been delivered. The Delivery Database 780 includes a plurality of records, each associated with an undelivered purchased item. Each record includes field for an undelivered item a delivery sequence number, order time, product code (e.g., bar code) of the item, description of the item, retailer store, customer information and delivery instruction. A block diagram of an exemplary Delivery Database 780 is shown in FIG. 10. Generally after a customer's order information is processed, the ESS 35 passes the information to the Order and Delivery Management Subsystem (ODMS) 85, in particular, adds a new record for each newly purchased item to the Delivery Database 780 of the ODMS 85. After the ESS 35 updates the Delivery Database 780, the ESS 35 may notify the LDS 40 of the change, of the Delivery Database. An Order Archive Database 785 contains information of delivered purchase. The Order Archive Database 785 may contain all the fields of an delivery database, and additional fields including the delivery status, delivery agent and delivery recipient. When an item is processed for delivery by the LDS 40, the record for that item is deleted from the Delivery Database 780 and a new record is added to the Order Archive Database 785.

FIG. 11 is a schematic diagram illustrating one embodiment of delivery arrangement between stores 10 and order delivery locations 800 designated by customers. In general, the delivery agents of the LDS 40 are responsible for deliveries. An order delivery locations 800 may be any of the location options that are among the choices A, B, C, and D in delivery options group 730 in FIG. 8B. That said, order delivery locations may include all locations of local ECSs 20 and storage units 68. An order livery location may further be a store location. An order delivery location may further be a place outside the shopping center 5. With referring to FIG. 11, the first delivery agent of the LDS 40, delivery agent No. 1, delivers ordered items from stores 1−M to desired locations 1−K. A second delivery agent, delivery agent No. 2, delivers ordered items from stores M+1−N to locations 1−K. A third delivery agent, delivery agent No. 3, delivers ordered items from stores 1−M to locations K+1-L, and so forth. It is apparent that for each delivery correspondence between a store and a client location, there is at least one deliver agent responsible for it. A delivery correspondence may be a delivery of purchased item from a store to a shopper. A delivery correspondence may simply be a in-store pick-up by customer, in which the delivery solely occurs within the store. A delivery correspondence may also be a pick-up of a returned merchandise from a shopper and delivery back to a store. A delivery correspondence may further include picking up items from a shopper and sending to a service provider for processing and after processing, delivering said processed items back to the shopper. It is noted not only a delivery may be initiated by an e-shopping order placed at a client system such as a local ECS 20 or a remote client system 60, but also a shopper doing physical shopping in a store of the shopping center may request a Store Operator 47 in FIG. 1 to initiate a delivery.

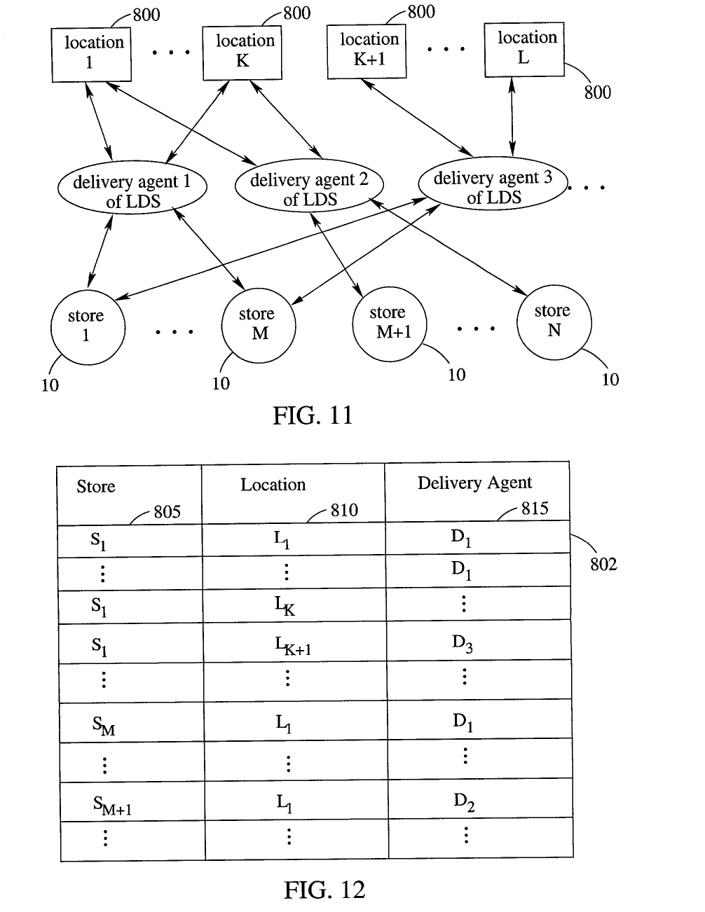

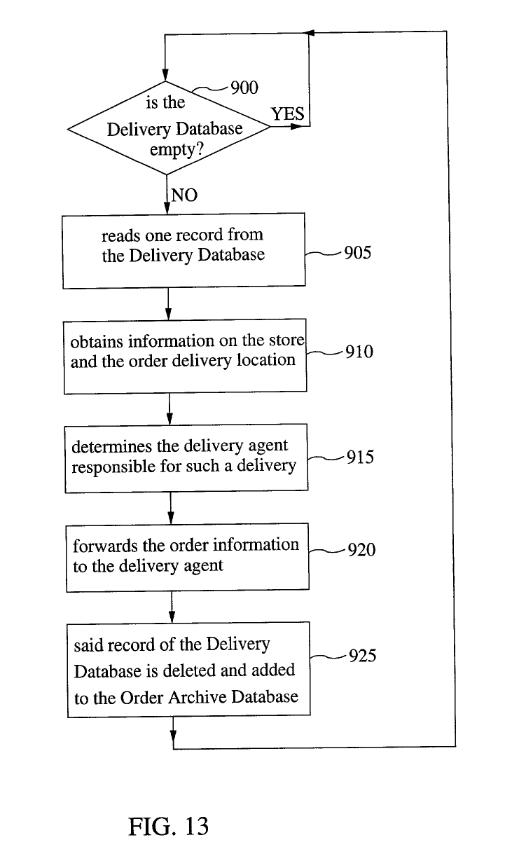

FIG. 12 illustrates an exemplary delivery-agent index table that maps a delivery to a delivery agent. A delivery-agent index table 802 includes a plurality of entries. Each entry includes Store field 805, Location field 810 and Delivery-Agent field 815. The index table 802 says a delivery between a store as indicated in the Store field 805 and an order delivery location as indicated in the Location field 810 is delivered by a delivery agent as indicated in the Delivery-Agent field 815. For example, a delivery between the store S₁ and the order delivery location L₁ is the responsibility of the delivery agent D₁. The descriptions of a store in the Store field 805, an order delivery location in the Location field 810 and a delivery agent in the Delivery-Agent field 815 can be any unique methods such as identification number or text description, that provides sufficient information to identify entries in the fields. It is noted that an entry in the Location field 810 may represent a group of locations, and a store entry in the Store field 805 can also represent a group of stores. FIG. 13 is a flow diagram that illustrates a routine used by the ESS 35 by which a delivery is scheduled. In step 900, if the Delivery Database 780 as illustrated in FIG. 10 is not empty, that is, the Delivery Database contains at least one item that needs to be delivered, then the routine continues at step 905, else the routine loops at this point and waits for new delivery records to be added to the database. In step 905, the ESS 35 in particular the server engine 70 reads in one record of the Delivery Database 780. In step 910, the ESS 35 retrieves the information of the selling store and the order deliver location from the retrieved delivery record of the Delivery Database 780. An order delivery location may be a multi-point-location. For example, in a situation that an order is a service request order, in which a delivery correspondence as described in FIG. 11 includes picking up items from a shopper and sending to a service provider for processing and after processing, delivering said processed items back to the shopper. The order delivery location is a multi-point-location includes the service provider location and the shopper location. In step 915, by looking up the delivery-agent index table 802 with the store and order delivery location information, the ESS 35 determines the delivery agent of the LDS 40 who will carry out such a delivery. In step 920, the ESS 35 forward the delivery information to the delivery agent of the LDS 40 through a communication interface means 50 such as a mobile phone or a mobile hand-held computer. The delivery agent then fulfills the delivery task as defined by the delivery record. In step 925, the ESS 35 deletes said record in the Delivery Database 780, and adds said record to the Order Archive Database 785. Then the routine loops back to step 900 for the next record.

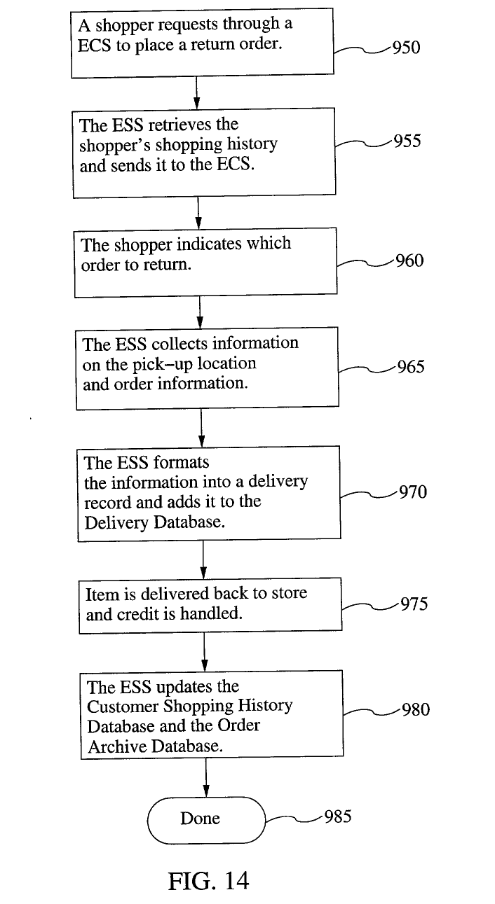

FIG. 14 illustrates process of returning an item from a shopper to a store. In step 950, a shopper requests through a client system preferably a local ECS 20 that he or she wants to return an order. Though a client system here is preferably a local ECS 20, it may also be a remote client system 60. In step 955, the ESS 35 retrieves the shopper's shopping history records from the Customer Shopping History Database 125, and formats them as Web pages and send to the ECS 20. The local ECS 20 then displays said order history information to the shopper. In step 960, the shopper indicates which order to return among the shopping history records. In step 965, the ESS 35 collects the return-order information and the pick-up location from the shopper. In step 970, the ESS 35 then formats the information to a delivery record and add the new record to the Delivery Database 780. The delivery of a return order from the shopper is then treated as a normal delivery described in FIG. 13. In step 975, a deliver agent of the LDS 40 comes to pick up the item and delivers it back to its respective supplier. Credit or refund may then be handled by the supplier upon receiving the returned item. In step 980, the ESS 35 updates the Customer Shopping History Database 125 and Order Archive Database 785 by marking the order as a canceled or returned order. In step 985, a return order is completed. In an alternative embodiment of the operation of a return order, the operation can starts by the ESS 35 directly collecting order information and pick-up location information from the shopper without looking up in the Customer Shopping History Database 125, and then continue at step 970. Apparently, the shopper may return the order by directly visiting the supplier.

It is noted that the herein described process of shopping using a local ECS 20 may be readily applied to a remote client system 60 without modification.

The many features and advantages of the present invention are apparent from the detailed specification, and primarily, it provides a novel shopping system of integrated electronic commerce and physical commerce. It is to be understood that the present invention is not limited to the embodiments illustrated and described herein, and variations and modifications may be readily occur to those skilled in the art without departing from the scope of the present invention.

I claim:

1. A method of effecting commerce, comprising steps of:
(a) providing a first means comprising at least one actual physically embodied supplier of products/services, in which a customer can receive from among a plurality of products/services;
(b) providing second means comprising display means and input means for interacting with a customer;
(c) maintaining an electronic-commerce (e-commerce) server system, comprising:
i. first storing means for storing data representing an inventory of products/services offered by said one actually embodied supplier at said first means;
ii. second storing means for storing data representing information related to customers;
iii. means for communicating information in said first storing means and said second storing means over a communication network.
(d) providing a communication network, whereby said second means and said electronic-commerce server system are connected and may communicate with each other;
(e) a customer using said second means to communicate with said electronic-commerce server system to place an order for products/services from said at least one actual physically embodied supplier;
(f) delivering said order to a location designated by said customer.

2. A method of claim 1, wherein said first means is a shopping mall.

3. A method of claim 1, wherein said first means is a commercial district shopping center.

4. A method of claim 1, wherein said second means are set up in a collective manner at said first means.

5. A method of claim 1, wherein said second means are set up in a distributive manner at said first means.

6. A method of claim 1, wherein said second means is a personal computer.

7. A method of claim 1, wherein said input means of said second means is a touch sensitive screen.

8. A method of claim 1, wherein said second means is a Personal Digital Assistant (PDA).

9. A method of claim 1, wherein said second means is a mobile electronic device.

10. A method of claim 1, wherein said second means further comprises means for communicating with a mobile device.

11. A method of claim 1, wherein said communication network is a local area network.

12. A method of claim 1, further comprising the step of communicating said customers over a wide area network.

13. A method of claim 1, further comprising the step of communicating said customers over the Internet.

14. A method of claim 1, further comprising the step of communicating said customers over a wireless network.

15. A method of claim 1, further comprising the step of a customer communicating with said at least one actual physically embodied supplier over a phone line.

16. A method of claim 1, wherein said communication network is a combination of at least two of a local area network, a wide area network, a wireless network and and the Internet.

17. A method of claim 1, further comprising the step of a customer identifying himself/herself at said second means.

18. A method of claim 1, further comprising the steps of:
(a) providing a storage means to a customer;
(b) delivering said order to said storage means.

19. A method of claim 1, wherein said delivering includes a substep of an in-store picking up by a customer.

20. A method of claim 1, further comprising the step of delivering items from at least one product/services suppliers at the first means to a plurality of locations.

21. A method of claim 1, wherein the step of said delivering include the substeps of:
(a) picking up an item from a first location selected by said customer;
(b) delivering said item to a second location selected by said customer for processing;
(c) delivering said item to a third location selected by said customer after processing.

22. A method of claim 1, wherein said order is a return order, further comprising the steps of:
(a) a customer using said second means to place a return order, indicating a desire to return an item back to a respective supplier at said first means;
(b) picking up said item from a first location indicated by said customer;
(c) delivering said item from said first location to a second location defined by said respective supplier.

23. A method of claim 1, further comprising the steps of:
(a) said customer refusing accepting at least one item from said order upon seeing the delivered said order;
(b) said refused item being delivered back to its respective supplier.

24. A method of claim 1, further comprising the step of providing means for said electronic-commerce server system to locate a customer at a second means without asking said customer to explicitly identify location of said second means.

25. A method of claim 1, further comprising the step of said electronic-commerce server system changing information in said first storing means and said second storing means in accordance with said order.

26. A method of claim 1, further comprising the step of providing means for tracking a customer's historical purchased items from said first means.

27. A method of claim 1, further comprising the steps of:
(a) providing third storing means for said electronic-commerce server system for storing products/services promotion information associated with said at least one actual physically embodied supplier;
(b) communicating said promotion information to a customer at said second means over said communication network.

28. A method of claim 1, further comprising the step of a customer using a shopping list to place an order at said second means, comprising the steps of:
(a) said customer building a first list of items;
(b) said customer submitting said first list to said electronic-commerce server system over said communication network;
(c) said electronic-commerce server system returning a list of items for sale at said first means;
(d) said customer using the returned list to build a second list of items for purchase;
(e) said customer submitting said second list of items to said electronic-commerce server system and thus completing order of said second list of items.

29. A method of claim 1, further comprising the step of a second customer using said first means to place an order from a supplier at said first means.

30. A method of claim 1 further comprising the steps of:
(a) maintaining a control means at a supplier at said first means, wherein said control means may communicate with said electronic-commerce server system over said communication network;
(b) an in-store customer checking out at least one item from said supplier with said control means;
(c) said control means indicating to said electronic-commerce server system to change information in said first storing means in accordance with said in-store customer checking out;
(d) said electronic-commerce server system accordingly changing information in said first storing means in accordance with said in-store customer checking out.

31. A method of claim 1, further comprising the steps of:
(a) maintaining a control means at a supplier at said first means, wherein said control means may communicate with said electronic-commerce server system over said communication network;
(b) an in-store customer providing identification information;
(c) said in-store customer checking out at least one item from said supplier with said control means;
(d) said control means indicating to said electronic-commerce server system to change information in said first storing means in accordance with said in-store customer checking out;
(e) said electronic-commerce server system accordingly changing information in said first storing means in accordance with said in-store customer checking out;
(f) said control means indicating to said electronic-commerce server system to change information in said second storing means in accordance with said in-store customer checking out and said identification information;
(g) said electronic-commerce server system accordingly changing information in said second storing means in accordance with said in-store customer checking out and said identification information.

32. An electronic shopping method using a portable shopping list, comprising steps of:
(a) providing a portable means, whereby a user may store a first list;
(b) providing a fixed means that is connected to an electronic-commerce site over a computer driven network;
(c) providing a communication interface, whereby said first list in said portable means is transfered to said fixed means;
(d) said user submitting said first list through said fixed means to said electronic-commerce site over said computer driven network;
(e) said electronic-commerce site returning a list of items for sale at said electronic-commerce site to said fixed means;
(f) said user using the returned list at said fixed means to construct a second list of items for purchase;
(g) said user submitting said second list of items at said fixed means to said electronic-commerce site and thus completing order of said second list of items.

33. An electronic shopping method of claim 32, wherein said portable means is a Personal Digital Assistant (PDA).

34. An electronic shopping method of claim 32, wherein said fixed means is a personal computer.

35. An electronic shopping method of claim 32, wherein said communication interface is a means for infrared signal communication.

36. An electronic shopping method of claim 32, wherein said communication interface is a means for radio frequency communication.
